(19) United States
(12) Patent Application Publication
(10) Pub. No.: US 2006/0072634 A1
(43) Pub. Date: Apr. 6, 2006

(54) Calibration methods for tunable lasers

(76) Inventor: Andrew J. Daiber, Emerald Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/955,394

(22) Filed: Sep. 30, 2004

(51) Int. Cl. H01S 3/10; H01S 3/13

(52) U.S. Cl. 372/20; 372/32; 372/98; 372/92

(57) ABSTRACT

Methods for calibrating tunable lasers. Various operational characteristics of a tunable laser, such as an external cavity diode laser (ECDL), are modeled using corresponding modeling equations. Corresponding calibration processes are performed for each operational characteristics to derive parameters corresponding to each modeling equation. In one embodiment, the calibration processes relate to calibration of resistive thermal devices (RTDs), wavelength calibration, power vs. gain medium current (PI) curve calibration, and output power calibrations. The corresponding parameters that are derived from the calibration processes are stored on-board the tunable laser. During laser operations, firmware instructions are executed to perform tuning functions employing the stored parameters.

### FIELD OF THE INVENTION

The field of invention relates generally to optical communication systems and, more specifically but not exclusively relates to enhanced tunable lasers and methods for calibrating tuning characteristics of such tunable lasers.

### BACKGROUND INFORMATION

There is an increasing demand for tunable lasers for test and measurement uses, wavelength characterization of optical components, fiberoptic networks and other applications. In dense wavelength division multiplexing (DWDM) fiberoptic systems, multiple separate data streams propagate concurrently in a single optical fiber, with each data stream created by the modulated output of a laser at a specific channel frequency or wavelength. Presently, channel separations of approximately 0.4 nanometers in wavelength, or about 50 GHz are achievable, which allows up to 128 channels to be carried by a single fiber within the bandwidth range of currently available fibers and fiber amplifiers. Greater bandwidth requirements will likely result in smaller channel separation in the future.

DWDM systems have largely been based on distributed feedback (DFB) lasers operating with a reference etalon associated in a feedback control loop, with the reference etalon defining the ITU wavelength grid. Statistical variation associated with the manufacture of individual DFB lasers results in a distribution of channel center wavelengths across the wavelength grid, and thus individual DFB transmitters are usable only for a single channel or a small number of adjacent channels.

Continuously tunable external cavity lasers have been developed to overcome the limitations of individual DFB devices. Various laser-tuning mechanisms have been developed to provide external cavity wavelength selection, such as mechanically tuned gratings used in transmission and reflection. External cavity lasers must be able to provide a stable, single mode output at selectable wavelengths while effectively suppress lasing associated with all other external cavity modes that are within the gain bandwidth of the cavity. At the same time, the lasers should be easily tunable to a standard communication channel, such as a channel within the ITU wavelength grid.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1a is a schematic diagram of a generalized external cavity laser for which various embodiments of the invention may be derived in accordance with the teachings and principles disclosed herein;

FIG. 1b is a schematic diagram illustrating a laser cavity defined by a partially-reflective front facet of a Fabry-Perot gain chip and a reflective element;

FIG. 2 is a diagram illustrating a relative position of a laser cavity's lasing modes with respect to transmission peaks defined by an intra-cavity etalon and channel selector;

FIG. 3 is a diagram illustrating the transmission characteristics of a pair of etalons used for tuning a laser output via a Vernier tuning mechanism,

FIG. 4 is a flowchart illustrating operations performed during calibration of a laser, according to one embodiment of the invention

FIG. 5 is a schematic diagram illustrating components of an exemplary external cavity diode laser (ECDL) used to explain the laser calibration and tuning operations described herein;

FIG. 6 is a flowchart illustrating operations performed during a resistive thermal device (RTD) calibration process, according to one embodiment of the invention;

FIG. 7 is a table illustrating exemplary calibration test measurements corresponding to the RTD calibration process of FIG. 6;

FIG. 8 is a flowchart illustrating operations performed during a wavelength calibration process under which an output wavelength of a laser is tuned using a pair of thermally-controlled etalons, according to one embodiment of the invention;

FIG. 9 is a table illustrating exemplary calibration test measurements corresponding to the wavelength calibration process of FIG. 8;

FIG. 10 is a flowchart illustrating operations performed during a power (P) vs. gain medium current (I) PI curve calibration process, according to one embodiment of the invention;

FIG. 11 is a table illustrating exemplary calibration test measurements corresponding to the PI curve calibration process of FIG. 10;

FIG. 12 is a graph illustrating an exemplary PI curve containing data derived from calibrating an ECDL;

FIG. 13 is a flowchart illustrating operations performed during an output power calibration process, according to one embodiment of the invention;

FIG. 14 is a table illustrating exemplary calibration test measurements corresponding to the output power calibration process of FIG. 15.

FIG. 15 is a flowchart illustrating operations performed during run-time (e.g., post calibration) operations of a laser, wherein parameters derived from calibration testing are employed to tune a laser using corresponding equations, according to one embodiment of the invention; and

FIG. 16 is a graph illustrating an exemplary set of frequency error vs. channel data resulting from one embodiment of the calibration processes described herein.

### DETAILED DESCRIPTION

Embodiments of methods for calibrating tunable lasers are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

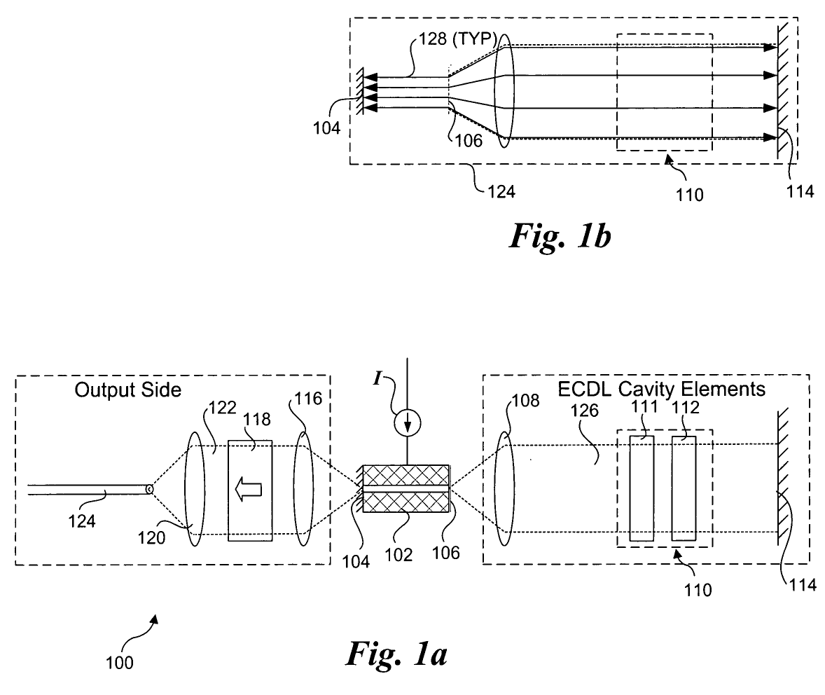

Discrete wavelength tunable diode lasers typically comprise a semiconductor gain medium, two reflectors, and an intra-cavity tuning mechanism. For example, as an overview, a generalized embodiment of an external cavity diode laser (ECDL) 100 is shown in FIG. 1. ECDL 100 includes a gain medium comprising a diode gain chip 102. Diode gain chip 102 comprises a Fabry-Perot diode laser including a partially-reflective front facet 104 and an anti-reflective rear facet 106 coated with an anti-reflective (AR) coating to minimize reflections at its face. Optionally, diode gain chip 102 may comprise a bent-waveguide structure on the gain medium to realize the non-reflective rear facet 106. The external cavity elements include a diode intracavity collimating lens 108, tuning filter element or elements 110, and a reflective element 114. In general, reflective element 114 may comprise a mirror, grating, prism, or other reflector or retroreflector, which may also provide the tuning filter function in place of tuning element 110. The output side components include a diode output collimating lens 116, an optical isolator 118, and a fiber focusing lens 120, which focuses an output optical beam 122 such that it is launched into an output fiber 124.

The basic operation of ECDL 100 is a follows. A controllable current I is supplied to diode gain chip 102 (the gain medium), resulting in a voltage differential across the diode junction, which produces an emission of optical energy (photons). The emitted photons pass back and forth between partially-reflective front facet 104 and reflective element 114, which collectively define the ends of an “effective” laser cavity (i.e., the two reflectors discussed above), as depicted by laser cavity 126 in FIG. 1b. As the photons pass back and forth, a plurality of resonances, or “lasing” modes are produced. Under a lasing mode, a portion of the optical energy (photons) temporarily occupies the external laser cavity, as depicted by intracavity optical beam 126 and light rays 128; at the same time, a portion of the photons in the external laser cavity eventually passes through partially-reflective facet 104.

Light comprising the photons that exit the laser cavity through partially-reflective front facet 104 passes through diode output collimating lens 116, which collimates the light into output beam 122. The output beam then passes through optical isolator 118. The optical isolator is employed to prevent back-reflected light from being passed back into the external laser cavity, and is generally an optional element. After the light beam passes through the optical isolator, it is launched into the output fiber 124 by fiber focusing lens 120. Generally, output fiber 124 may comprise a polarization-preserving type or a single-mode type such as SMF-28.

Through appropriate modulation of the input current (generally for communication rates of up to 2.5 GHz) or through modulation of an external element disposed in the optical path of the output beam (not shown) (for 10 GHz and 40 GHz communication rates), data can be modulated on the output beam to produce an optical data signal. Such a signal may be launched into a fiber and transmitted over a fiber-based network in accordance with practices well known in the optical communication arts, thereby providing very high bandwidth communication capabilities.

The lasing mode of an ECDL is a function of the total optical path length between the cavity ends (the cavity optical path length); that is, the optical path length encountered as the light passes through the various optical elements and spaces between those elements and the cavity ends defined by partially-reflective front facet 104 and reflective element 114. This includes diode gain chip 102, diode intracavity collimating lens 108, tuning filter element(s) 110, plus the path lengths between the optical elements (i.e., the path length of the transmission medium occupying the ECDL cavity, which is typically a gas such as air). More precisely, the total optical path length is the sum of the path lengths through each optical element and the transmission medium times the coefficient of refraction for that element or medium.

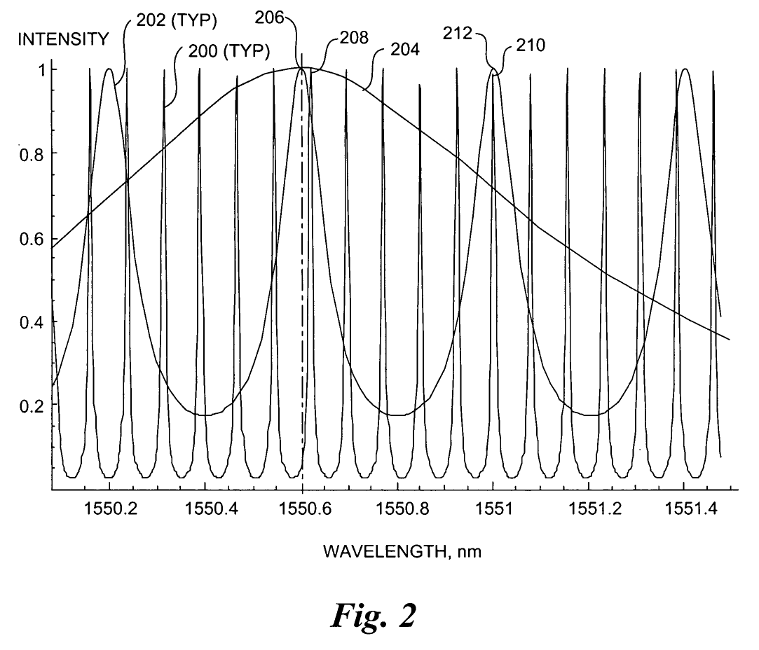

As discussed above, under a lasing mode, photons pass back and forth between the cavity end reflectors at a resonance frequency, which is a function of the cavity optical path length. In fact, without the tuning filter elements, the laser would resonate at multiple frequencies. Longitudinal laser modes occur at each frequency where the roundtrip phase accumulation is an exact multiple of 2π. For simplicity, if we model the laser cavity as a Fabry-Perot cavity, these frequencies can be determined from the following equation:

$$L = \frac{λ x}{2 n} \qquad ( 1 )$$

where λ=wavelength, L=optical length of the cavity, x=an arbitrary integer×1, 2, 3, . . . , and n=refractive index of the medium. The average frequency spacing can be derived from equation (1) to yield:

$$Δ v = \frac{c}{2 L} \qquad ( 2 )$$

where frequency v=c/λ and c is the speed of light. The number of resonant frequencies is determined from the width of the gain spectrum. The corresponding lasing modes for the cavity resonant frequencies are commonly referred to as “cavity modes,” an example of which is depicted by cavity modes 200 in FIG. 2.

Semiconductor laser gain media typically have broad gain spectra and therefore require spectral filtering to achieve longitudinal mode operations (i.e., operations at a single wavelength or frequency). In order to produce an output at a single frequency, filtering mechanisms are employed to substantially attenuate all lasing modes except for the lasing mode corresponding to the desired frequency. As discussed above, in one scheme a pair of etalons, depicted as a grid generator 111 and a channel selector 112 in FIG. 1. The grid generator, which comprises a static etalon that operates as a Fabry-Perot resonator, defines a plurality of transmission peaks (also referred to as passbands) in accordance with equations (1) and (2). Ideally, during operation the transmission peaks remained fixed, hence the term “static” etalon; in practice, it may be necessary to employ a servo loop (e.g., a temperature control loop) to maintain the transmission peaks at the desired location. Since the cavity length for the grid generator is less than the cavity length for the laser cavity, the spacing (in wavelength) between the transmission peaks is greater for the grid generator than that for the cavity modes.

A set of transmission peaks 202 corresponding to an exemplary etalon grid generator is shown in FIG. 2. Note that at the peaks of the waveform the intensity (relative in the figure) is a maximum, while it is a minimum at the troughs. Generally, the location and spacing of the transmission peaks for the grid generator will correspond to a set of channel frequencies defined by the communication standard the laser is to be employed for, such as the ITU channels and 0.04 nanometer (nm) spacing discussed above and depicted in FIG. 2. Furthermore, the spacing of the transmission peaks corresponds to the free spectral range (FSR) of the grid generator.

As discussed above, a channel selector, such as an adjustable etalon, is employed to select the lasing mode of the laser output. For illustrative purposes, in one embodiment channel selector 112 may comprise an etalon having a width substantially less than the etalon employed for the grid generator. In this case, the FSR of the channel selector is also substantially greater than that of the grid generator; thus the bandpass waveform of the channel selector is broadened, as illustrated by channel selector bandpass waveform 204 having a single transmission peak 206. In accordance with this channel selection technique, a desired channel can be selected by aligning the transmission peak of the channel selector (e.g. 206) with one of the transmission peaks of the grid generator. For example, in the illustrated configuration depicted in FIG. 2, the selected channel has a frequency corresponding to a laser output having a 1550.6 nm wavelength.

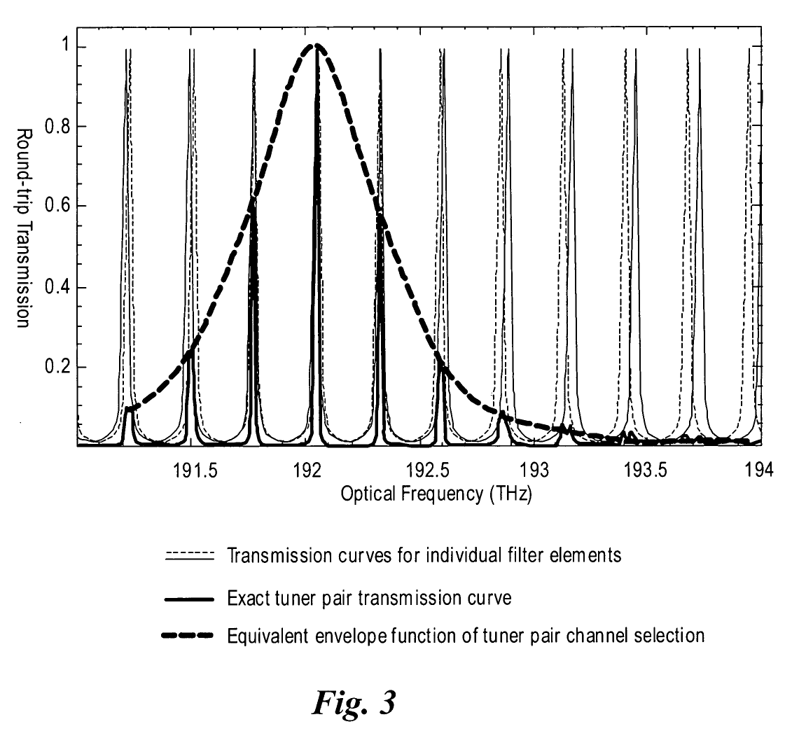

In addition to the foregoing scheme, several other channel selecting mechanisms may be implemented, including rotating a diffraction grating; electrically adjusting a tunable liquid crystal etalon; mechanically translating a wedge-shaped etalon (thereby adjusting its effective cavity length); and “Vernier” tuning, wherein etalons of the same finesses and slightly different FSRs are employed, and a respective pair of transmission peaks from among the transmission peaks defined by the etalons are aligned to select the channel in a manner similar to that employed when using a Vernier scale. An illustration of the transmission characteristics of a pair of etalon filters used to facilitate Vernier tuning is shown in FIG. 3.

Note that in the illustrated example of FIG. 2, the transmission peak 208 of the cavity mode nearest the selected channel is misaligned with the transmission peaks for the grid generator and channel selector. As a result, the intensity of the laser output is attenuated due to the misalignment, which is reflected in the form of cavity losses. Various mechanisms may be employed to shift the cavity mode transmission peaks such that they are aligned with the grid generator and channel selector transmission peaks, thus yielding a maximum intensity in the laser output. Generally, under such schemes the optical path length of the laser cavity is adjusted so that it equals a multiple half-wavelength (λ/2) of the transmission wavelength selected by the grid etalon and channel selector (i.e., the wavelength at which grid etalon and channel selector transmission peaks are aligned). In one embodiment known as “wavelength locking,” an electronic servo loop is implemented that employs a modulated excitation signal that is used to modulate the overall cavity optical path length, thereby producing wavelength and intensity modulations in the laser output. A detection mechanism is employed to sense the intensity modulation (either via a measurement of the laser output intensity or sensing a junction voltage of the gain medium chip) and generate a corresponding feedback signal that is processed to produce a wavelength error signal. The wavelength error signal is then used to adjust the unmodulated (i.e., continuous) overall cavity optical path length so as to align the transmission peak of the cavity mode with the transmission peaks of the grid generator and channel selector.

Under one technique, the transmission characteristics of the filters are “tuned” by controlling the temperature of each filter. Changing the temperature of a filter causes its optical characteristics to change in a manner that shifts the location of the filter's transmission peaks. For example, the index of refraction of some filter materials may be changed by changing the temperature of the filter. In other cases, a change in temperature changes the thickness of the filter. In other situations a combined effect is produced. The result is that the optical path length of the Fabry-Perot etalon changes, thus altering its transmission characteristics.

The conventional technique for calibrating similar lasers that employ thermally-tunable etalons, as well as wavelength lockers employing similar filters is to servo the tuning mechanism (e.g., filter temperatures) until the correct wavelength is achieved and then record the immediate tuning parameters in a lookup table. This method has been shown to be too slow and too costly. For example, this foregoing calibration sequence must be repeated 84 times for a laser designed to be used in the 84-channel C-band spectrum. The technique may also be prone to inaccuracies resulting from using improper or incorrect input parameters for a given channel, for example

The embodiments of the invention describe herein employ equations to model the behavior of the laser's of entire range of accessible wavelengths and powers. Mathematical (e.g., physical model) equations employing various parameters are used to model the behavior, with the parameters being determined during calibration processes. The parameters and the same or related equations embodied as firmware are then stored on-board the laser and used during subsequent operations to tune the laser to selected channels and operate the laser at selected power levels. For convenience, these equations are generally referred to as “physical model equations” or “modeling equations” herein.

It is further noted that the equations presented below are not limited to physical model equations. In some cases, an equation is based on a corresponding physical model. In other cases, the equations are simply polynomial equations that may or may not be representative of a corresponding physical model. In other instances, the equations are simplifications of a physical model, wherein less-complex equations are used for practical purposes.

Overall, each of the foregoing types of equations perform a similar purpose. That purpose is to employ a single equation whose variables are valid over the entire operating range of a laser. As such, the single equation may be employed in place of conventional approaches, such as lookup tables. Furthermore, any position on a function's curve may be derived directly from the corresponding equation, without the need for performing linear or cubic interpolations between lookup points in a table.

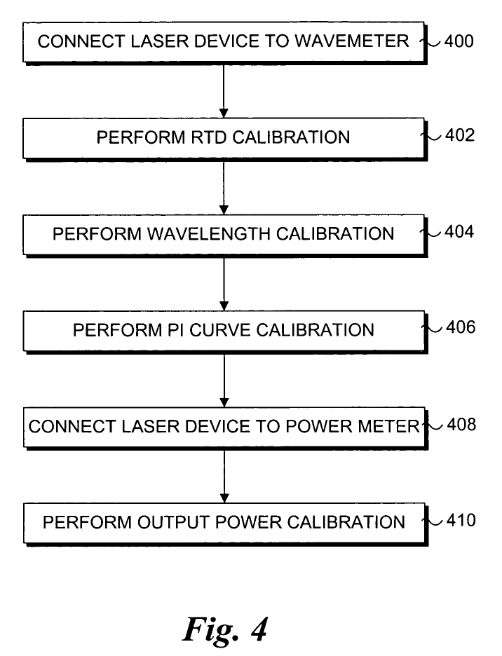

An overview of the calibration process is illustrated by the flowchart of FIG. 4. The process begins in a block 400, wherein the laser device being tested is connected to a wavemeter. In a block 402 a resistive thermal device (RTD) calibration is performed. Next, in a block 404, a wavelength calibration is performed. A power (P) vs. current (I) curve is then calibrated in a block 406. Following this operation, the laser device is connected to a power meter in a block 408, with an output power calibration operation being performed in a block 410.

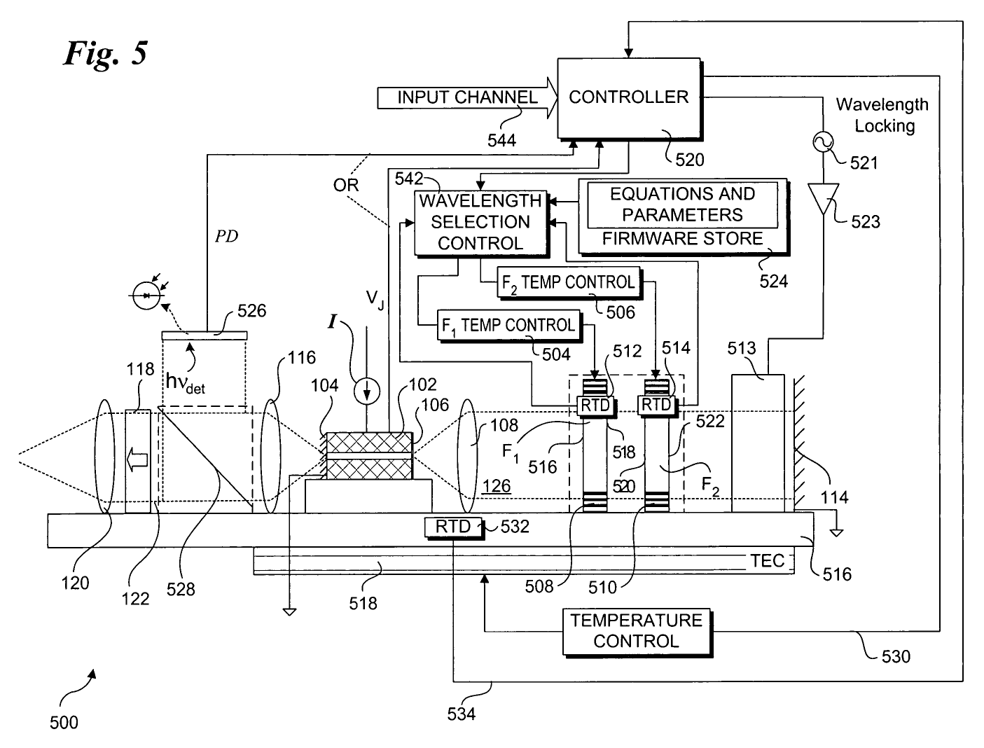

In order to better understand the following calibration processes, the processes will be described in connection with an exemplary ECLD 500 shown in FIG. 5. ECDL 500 includes various elements common to ECDL 100 having like reference numbers, such as a gain diode chip 102, lenses 108, 116, and 120, etc. The various optical components of ECDL 500 are mounted or otherwise coupled to a thermally-controllable base or “sled” 516. In one embodiment, one or more thermal-electric cooler (TEC) elements 518, such as a Peltier element, are mounted on or integrated in sled 516 such that the temperature of the sled can be precisely controlled via an electrical input signal. Due to the expansion and contraction of a material in response to a temperature change, the length of the sled can be adjusted very precisely. Adjustment of the length results in a change in the distance between partially reflective front facet 104 and reflective element 114, which produces a change in the optical path length of the laser cavity. As a result, controlling the temperature of the sled can be used to provide fine adjustment of the frequency of the lasing mode, such as used in the channel-locking mode discussed above.

In general, temperature control of the sled will be used for very fine tuning adjustments, while coarser tuning adjustments will be made by means of tuning filter elements 110. In the illustrated embodiment, tuning filter elements 110 comprise first and second tunable filters F_{1 and F}₂. In one embodiment, filters F_{1 and F}₂ comprise respective thermally-tunable etalons, either made of a solid material or being gas filled. In one embodiment, filter tuning is effectuated by changing the optical path length of each etalon. This, in turn, may be induced by changing the temperature of the etalons.

For example, ECDL 500 shows details of an exemplary channel selection subsystem. The subsystem includes a controller 520 that interfaces with a wavelength selection control block 542. It is noted that although the wavelength selection control block is shown external to controller 520, the control aspects of this block may be provided by the controller alone. In response to an input channel command 544, the controller and/or wavelength selection control block adjust the tuning filter element(s) so as to produce a lasing mode corresponding to the desired channel frequency (or equivalent wavelength). Wavelength selection control block 542 provides electrical outputs 504 and 506 for controlling the temperatures of filters F₁ and F₂, respectively. In one embodiment, a temperature control element is disposed around the perimeter of a circular etalon, as depicted by TECs 508 and 510. Respective RTDs 512 and 514 are employed to provide a temperature feedback signal back to wavelength selection control block 542.

Generally, etalons are employed in laser cavities to provide filtering functions. As discussed above, they essentially function as Fabry-Perot resonators, and provide a filtering function defining a set of transmission peaks in the laser output. The FSR spacing of the transmission peaks is dependent on the distance between the two faces of the etalon, e.g., faces 516 and 518 for filter F₁, and faces 520 and 522 for filter F₂. As the temperatures of the etalons change, the etalon material is caused to expand or contract, thus causing the distance between the faces to change. Also, as discussed above, the change in temperature may alter the index of refraction for an etalon, or a combined effect may result. This effectively changes the optical path length of the etalons, which may be employed to shift the transmission peaks.

The effect of the filters is cumulative. As a result, all lasing modes except for a selected channel lasing mode can be substantially attenuated by lining up a single transmission peak of each filter. In one embodiment, the configurations of the two etalons are selected such that the respective fee spectral ranges of the etalons are slightly different. This enables transmission peaks to be aligned under a Vernier tuning technique similar to that employed by a Vernier scale, such as shown in FIG. 3. In one embodiment, one of the filters, known as a “grid generator,” is configured to have a free spectral range corresponding to a communications channel grid, such as the ITU wavelength grid. This wavelength grid remains substantially fixed by maintaining the temperature of the corresponding grid generator etalon at a predetermined temperature. At the same time, the temperature of the other etalon, known as the channel selector, is adjusted so as to shift its transmission peaks relative to those of the grid generator. By shifting the transmission peaks of the filters in this manner, transmission peaks corresponding to channel frequencies may be aligned, thereby producing a cavity lasing mode corresponding to the selected channel frequency. In another embodiment, the transmission peaks of both the etalon filters are shifted to select a channel.

In general, embodiments of the tunable ECDLs described herein may employ a wavelength-locking (also referred to as channel-locking) scheme so as to maintain the laser output at a selected channel frequency (and thus at a corresponding predetermined wavelength). Typically, this may be provided via a “phase modulation” scheme, wherein the optical path length of the laser cavity is modulated at a relatively low frequency (e.g., 500 Hz-20 KHz) at a small frequency excursion. In one embodiment, an optical path length modulator 513 is employed for this purpose. In response to a modulated wavelength locking excitation signal 521 generated by controller 520 and amplified by an amplifier 523, the optical path length of modulator 513 is caused to modulate, thereby inducing a wavelength modulation and in the laser's output. Generally, the optical path length modulator may comprise an element that changes its optical path length in response to an electrical input, such as a Lithium Niobate (LiNbO₃) phase modulator. Lithium Niobate is a material that changes its index of refraction (ratio of the speed of light through the material divided by the speed of light through a vacuum) when a voltage is applied across it. As a result, by providing a modulated voltage signal across the LiNbO₃ phase modulator, the optical path length of the external laser cavity can be caused to modulate. Other means of modulating the optical path length of the laser cavity may be employed as well, such as modulating the location of reflective element 114 (e.g., via a MEMS mirror or a reflector coupled to a piezo-electric actuator). Another technique is to employ a gain medium with a phase control section that changes its optical path length in response to an injected current.

As is well-known in the art, when the laser's output has a frequency that is centered on a channel frequency (in accordance with appropriately configured filter elements), the laser intensity is maximized relative to non-centered outputs. As a result, the wavelength modulation produces an intensity modulation having an amplitude indicative of how off-center the lasing mode is. A corresponding feedback signal may then be generated that is received by controller 520 and processed to adjust the overall cavity length via a sled temperature control signal 530.

For example, in the illustrated embodiment of FIG. 5, a photodetector 526 is used to detect the intensity of the laser output. A beam splitter 528 is disposed in the optical path of output beam 122, causing a portion of the output beam light to be “split” off and redirected toward photodetector 526. In one embodiment, photodetector 526 comprises a photodiode, which generates a voltage charge in response to the light intensity it receives (hv_{det}). The voltage charge is converted into a photodiode current PD that is then fed back to controller 520.

Controller 520 includes a digital servo loop (e.g., phase lock loop) that is configured to adjust the temperature of sled 516 such that the amplitude modulation of the light intensity detected at photodetector 526 is minimized, in accordance with a typical intensity vs. frequency curve for a given channel and corresponding filter characteristics. In an optional embodiment, the junction voltage across gain diode chip (V_{J}) is employed as the intensity feedback signal, rather than PD. An error signal is then derived by based on the amplitude modulation and phase of PD or V_{J} in combination with modulated signal 522. In response to the error signal, an appropriate adjustment in temperature control signal 530 is generated. Adjustment of the sled temperature causes a corresponding change in the overall (continuous) cavity length, and thus the lasing frequency. This in turn results in (ideally) a decrease in the difference between the lasing frequency and the desired channel frequency, thus completing the control loop. To reach an initial condition, or for a second feedback signal, a RDT 732, such as a thermister or thermocouple, may be used to provide a temperature feedback signal 534 to controller 520.

In general, controller 520 may include one or more analog-to-digital (A/D) converters, or separate A/D converters may be employed. Although photodiode current and gain medium current measurements are described herein, it is noted that these measurements are ultimately made by using appropriate circuitry to convert the currents into voltage level signals, which in turn are measured using the A/D converter(s).

The RTD calibration operation of block 302 is used to calibrate the RTD temperature sensors 512 and 514 used for each of the etalon filters F_{1 and F}₂. RTDs are thermal devices that measure temperature via a change in their resistance, hence the name resistive thermal device. RTDs are made of many different materials, with certain materials being targets for corresponding temperature ranges. In one embodiment, platinum RTDs are used in the laser to measure the etalon temperatures.

There is a nearly linear dependence between resistance and temperature of platinum over the operating range of the etalons. Accordingly, the resistance R is modeled by the following equation:
R=R₂₅+α*(T−25) (3)
wherein the parameters being solved for include R₂₅, which is the resistance of the RTD at 25° C., and α is the linearity constant. The variables are R, which is the resistance converted from an A/D converter, and T, the temperature.

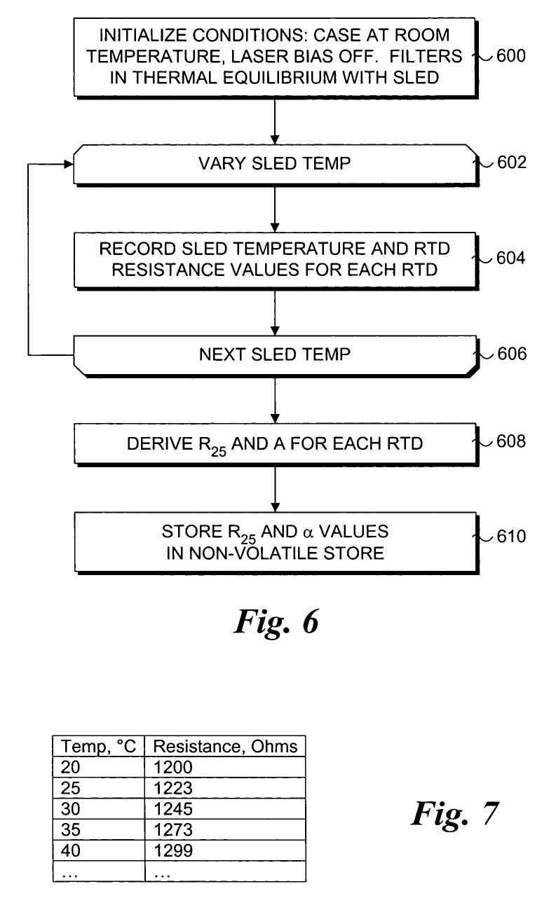

Referring to the flowchart of FIG. 6, one embodiment of the RTD calibration process begins by initializing test conditions in a block 600. The case of the ECDL is maintained at room temperature, with the laser bias off. The etalon filters F₁ and F₂ are then allowed to be in thermal equilibrium with sled 516.

In a start loop block 602, the temperature of sled 516 is varied by adjusting the current to TEC 518 via temperature control signal 530. In a block 604, the sled temperature and the RTD resistance for each of RTDs 512 and 514 is recorded. In one embodiment, a thermister is attached to sled 516, and a corresponding calibration curve is used establish the sled temperature via the thermister. In other embodiments, other external temperature measurements may be employed for calibration purposes. As depicted by start and end loop blocks 602 and 606, the operations in a block 604 are performed over a number of different temperatures. An exemplary set of temperatures and resistances are shown in FIG. 7.

After recording RTD resistances at a number of different temperatures, the values for parameters R₂₅ and a are derived in a block 608. In one embodiment, the value for R₂₅ is simply derived from the resistance of the RTD resistance measured when the sled temperature is at 25° C. In other embodiments, the value for R₂₅ may be interpolated from other sled temperature and RTD resistance measurements. In one embodiment, a least squares fit is used to derive a based on the calibration test data, as is well-known in the mathematical arts.

Equation 3 defines a linear model for modeling the temperature of a filter based on its RTD measurement. In another embodiment, a more complex model, such as a quadratic model may be used. Techniques for deriving quadratic model parameters from two-input variable calibration test are well-known, and as such, a description of this process is not discussed herein. In general, the linear model is advantageous over a quadratic model with respect to computational efficiency. Meanwhile, the quadratic model is generally more accurate. However, since platinum RTDs exhibit a very linear resistance vs. temperature behavior, a linear model has shown to be sufficiently accurate for temperature measurements. Furthermore, there are no laser performance parameters that depend critically on the accuracy of the temperature scale.

Returning to FIG. 4, the next operation after RTD calibration is the wavelength calibration process of block 404. As discussed above, a Fabry-Perot etalon has transmission maxima (i.e., filter transmission peaks) at periodic frequencies based on equation 1. Rearranging the terms of equation 1, and substituting q for x, Fabry-Perot etalons have transmission maxima when:

$$q * \frac{λ}{2} = n * L \qquad ( 4 )$$

wherein q is an integer.

In view of equation 4 and other considerations, the transmission characteristics of the filters are modeled by the following equation:

$${q}_{0} + dq = \frac{v}{c} * 2 * n ( λ , T ) * L * ( 1 + A * T + B * {T}^{2} ) \qquad ( 5 )$$

The foregoing equation defines four fit parameters for each filter: A, B, q₀ and L. The variables includes v, the optical frequency, T, the filter temperature, and dq, the relative peak integer. n(λ, T), the index of refraction for the etalon material at a corresponding wavelength and temperature, is a constant that can be obtained for existing tables for the material used for the etalons. In one embodiment, the etalons are made of silicon. Physically, the fit parameters correspond to the absolute mode number q₀ of the relative mode 0, the etalon thickness L, and corrections to the slope (A) and curvature (B) of the temperature scale.

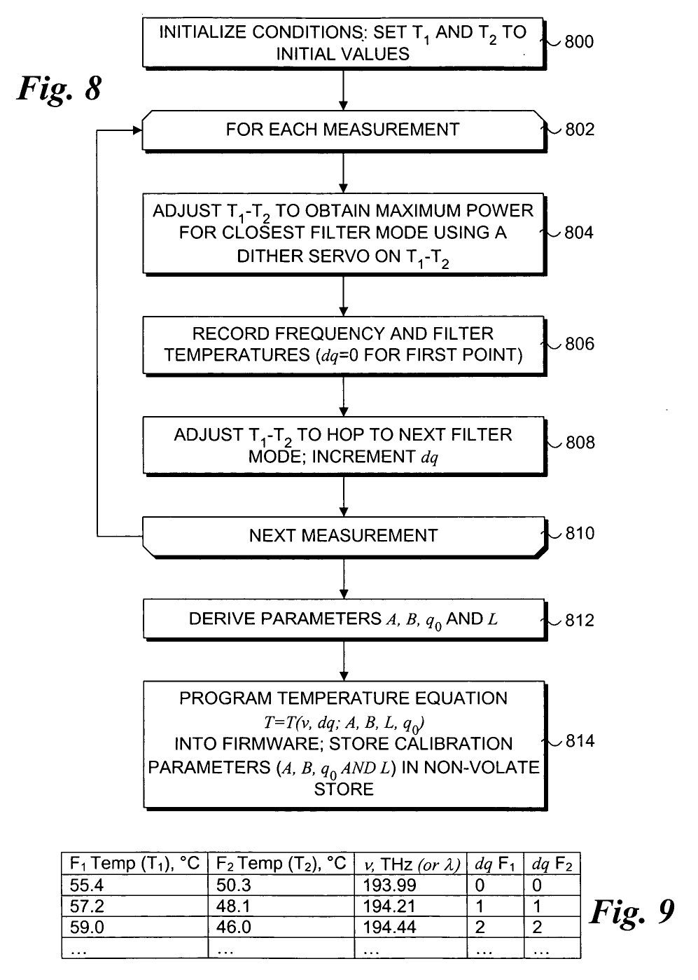

Referring to the flowchart of FIG. 8, one embodiment of the wavelength calibration process proceeds as follows. In a block 800, respective temperatures T₁ and T₂ for filters F₁ and F₂ are set to initial values. The following operations depicted in blocks 804, 806, and 808 are then performed for each measurement, as depicted by start and end loop blocks 802 and 810.

In block 804, the difference between the filter temperatures, T₁−T₂, is adjusted until a maximum power value for the closest filter mode (e.g., closest combined filter transmission peak) is obtained, using a dither servo on the filter temperature difference in a similar manner to that described above for wavelength locking. In one embodiment, the power measurement is made by photodetector 526, which produces a photodiode current PD that is proportional to the optical power received at the photodiode. This, in turn, is indicative of the optical power of the laser's output (measured internally). Once the maximum power filter configuration is reached, the frequency and filter temperatures for the corresponding dq value are recorded in block 806.

The next measurement cycle is then initiated in block 808, wherein the filter temperature difference T₁−T₂ is adjusted to “hop” the laser to the next filter mode. In one embodiment, this is obtained by increasing the temperature difference by a predetermined value. Furthermore, in one embodiment, the increase in filter temperature difference is obtained by concurrently increasing the temperature of one filter while decreasing the temperature of the other. This technique is particularly applicable under the Vernier tuning configuration discussed above. The value of dq is also incremented by one prior to performing the next measurement cycle.

As shown in FIG. 9, the data measurement routine returns a table with the following columns: Filter F₁ temperature (T₁), filter F₂ temperature (T₂), the observed frequency v or wavelength λ, an integer (dq F₁) describing which etalon peak on filter F₁ was used to reach this frequency or wavelength relative to the other entries in the table, and a similar integer (dq F₂) for describing the etalon peak of filter F₂. The relative peak information is determined by keeping track of which superchannel is being used for each measurement. For example, assign relative peaks (0,0) to the first data point, adjust the filter temperature difference until the wavelength hops to the next mode, which will corresponding to relative peaks (1,1), hop again to relative peaks (2,2) etc.

After the measurements have been made, the parameters A, B, q₀ and L are derived from the measurement data using least squares fit between the data and the parameterized model, as depicted in a block 812. The process is completed in a block 814, wherein the laser tuning equation,
T=T(v, dq, A, B, L, q₀) (6)
Is solved for T and is programmed into the system's firmware, while the calibrated parameters (A, B, q₀ and L) are stored in a non-volatile store, such as Flash memory. In one embodiment, the calibrated parameters are stored along with firmware for the laser in a firmware store 524. Generally, firmware store 524 is representative of a non-volatile storage device that is either on-board the laser or an external device that is accessible to the laser via an appropriate communication link. In other embodiments, the calibration parameters and firmware may be stored in separate storage devices, either on-board the laser or comprising a combination of on-board and external storage devices. In one embodiment, the calibration parameters are stored in an external memory that is accessible to the laser via a standard or proprietary communication link. In yet another embodiment, the calibration parameters are stored on an external computer that is linked in communication with the laser via an appropriate communication interface, such as a network interface, serial interface, or the like.

In addition to wavelength calibration, the PI curve calibration process of block 406 is performed. This is used to calculate the estimated start gain medium current (Iₛₜₐᵣₜ) based on the photodiode power target and the tuning frequency target. This estimated start current is used to set the initial operating point for power control. Immediately after the estimated current is set, current adjustments by the power control servo begins. In one embodiment, the calibration data for wavelength calibration and PI curve calibration data are measured at the same time.

The PI curve is modeled using the following equation:

$$\begin{matrix}PD = η * ( I - {I}_{th} ) * \frac{( 1 - 0.5 * ( I - {I}_{th} )}{( {I}_{r} - {I}_{th} )} \\ wherein , & ( 7 ) \\ {I}_{th} = {a}_{0} + {a}_{1} * v + {a}_{2} * {v}^{2} + {a}_{3} * {v}^{3} \\ and , & ( 8 ) \\ η = {b}_{0} + {b}_{1} * v + {b}_{2} * {v}^{2} + {b}_{3} * {v}^{3} . & ( 9 )\end{matrix}$$

The parameters for the PI curve calibration model include Iᵣ, a₀, a₁, a₂, a₃, b₀, b₁, b₂, and b₃. Iᵣ is a quadratic parameter describing the thermal rollover of the PI curve. In one embodiment, Iᵣ is a scaled in units of mA (milliamps). The remaining parameters a₀, a₁, a₂, a₃, b₀, b₁, b₂, and b₃ are quadratic parameters. The variables include v, the optical frequency, I, the gain medium current, and PD, the photodiode current. Iₜₕ is the threshold current for the gain medium.

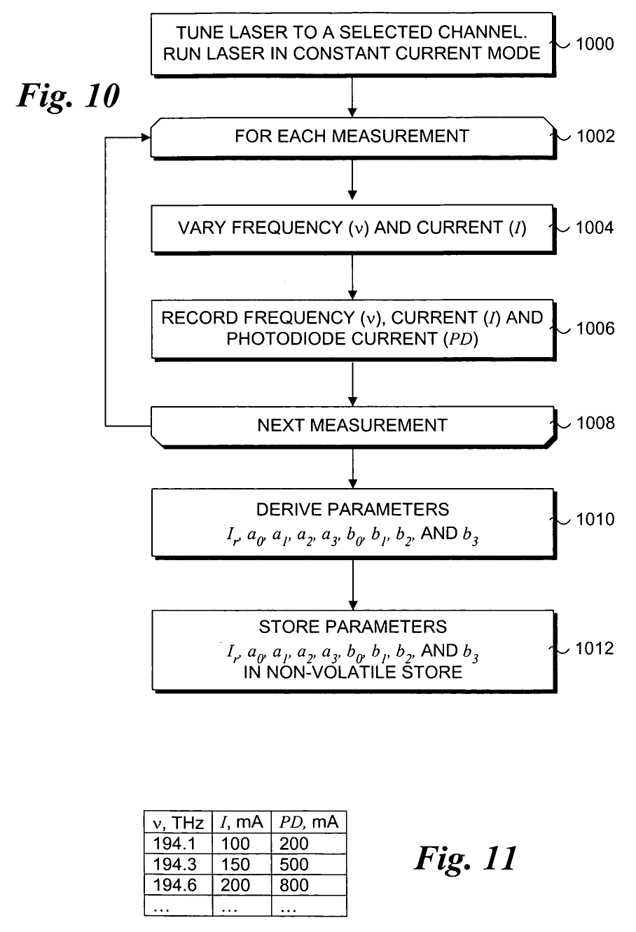

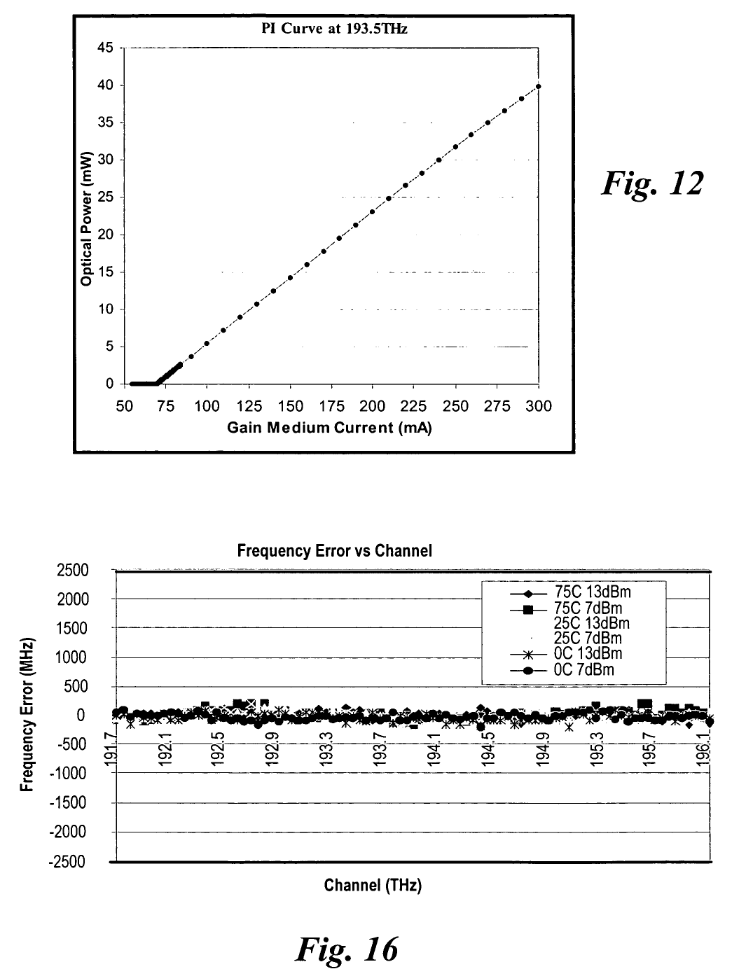

Referring to the flowchart of FIG. 10, one embodiment of the PI curve calibration process proceeds as follows. In a block 1000, the laser is tuned to a selected channel, and the laser is run in a constant current mode. As depicted by start and end loop blocks 1002, and 1008, the operations of blocks 1004 and 1006 are then performed for each measurement.

In block 1004 the frequency v and current I are varied. In block 1006, the frequency, current and photodiode current (PD) values are recorded, generating a table with like columns, as shown in FIG. 11. Under configuration of ECDL 500 in FIG. 5, the PD value is measured by photodetector 526. After the measurements are completed, the parameters Iᵣ, a₀, a₁, a₂, a₃, b₀, b₁, b₂, and b₃ are derived from the recorded measurement data in a block 1010, and the parameters are then stored in a non-volatile store in a block 1012. As before, the non-volatile store and the firmware store may comprise the same storage device (e.g., firmware store 524).

Returning to FIG. 4, the calibration process is completed by connecting the laser device to a power meter in block 408 and performing an output power calibration in block 410. More specifically, the output power calibration is used to calibrate the output power P of the laser (as measured externally) with the photodiode current PD (an internal power measurement). In general, there is a linear relation between the output power and photodiode measurement. However, since a photodiode is more sensitive at some frequencies than others, the photodiode current PD exhibits spectral sensitivity. This requires a more complex model than a simple linear relationship. As a result of this calibration, a target output power P of the laser can be obtained by adjusting the laser to produce a corresponding photodiode current PD at the targeted channel frequency v as defined by an appropriate calibration function and derived parameters.

In one embodiment, the following power calibration polynomial equation is used:
PD=P*d₀*(1+d₁*v+d₂*v²+d₃*v³) (10)
wherein the parameters include d₀, d₁, d₂, and d₃, and the input variables are the optical frequency v, the output power P, and the photodiode current PD.

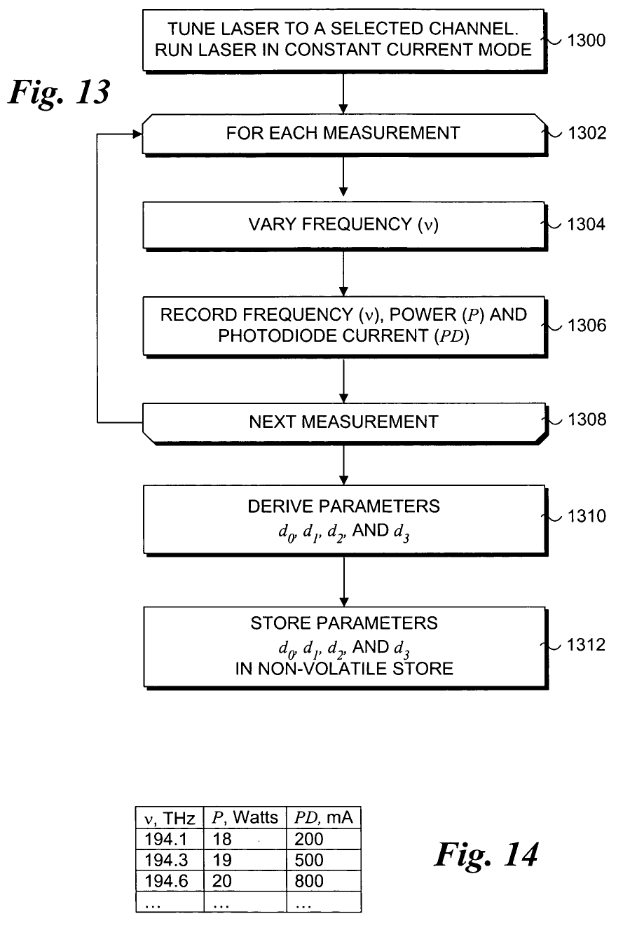

Referring to the flowchart of FIG. 13, one embodiment of the PI curve calibration process proceeds as follows. In a block 1300, the laser is tuned to a selected channel, and the laser is run in a constant current mode. As depicted by start and end loop blocks 1302, and 1308, the operations of blocks 1304 and 1306 are then performed for each measurement.

In block 1304 the frequency v is varied, while keeping the current constant. In block 1306, the frequency (v), output power (P) and photodiode current (PD) values are recorded, generating a table with like-named columns, as shown in FIG. 14. As before, under the configuration of ECDL 500 in FIG. 5, the PD value is measured by photodetector 526. After the measurements are completed, the parameters d₀, d₁, d₂, and d₃ are derived from the recorded measurement data in a block 1310 using a least-squares fit, and the parameters are then stored in a non-volatile store in a block 1312.

Once the foregoing calibration processes are completed, the laser is ready for field operations. During these operations, execution of firmware on-board the laser loads the parameters and equations into their corresponding functions, and then the functions are executed to assist tuning of the laser. The equations, which interpolate performance over an entire range of applicable input variables, provide accurate models of the laser's performance.

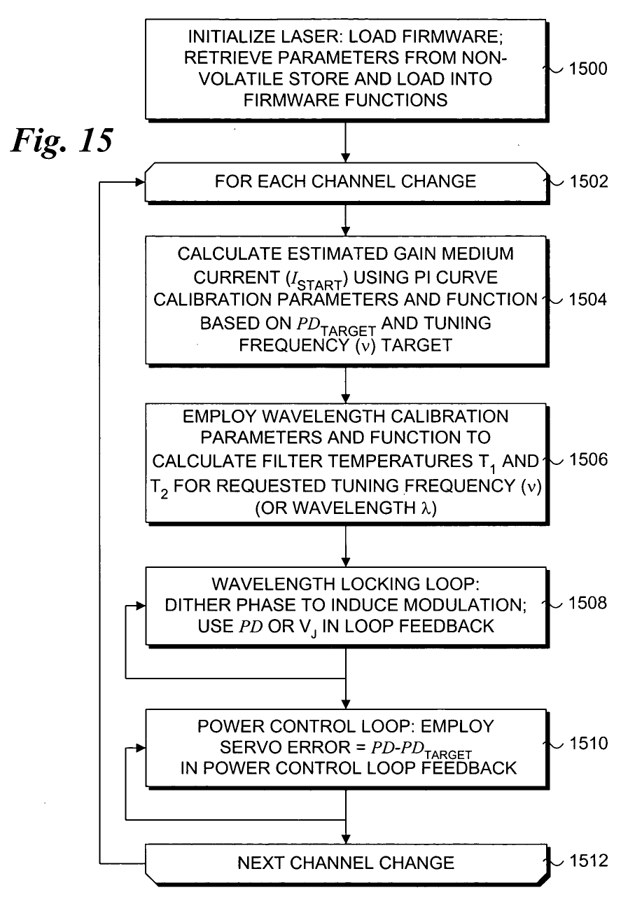

Referring to FIG. 15, laser operations corresponding to one embodiment proceed as follows. In a block 1500, the laser is initialized. Among the initialization operations is loading the laser's firmware, which typically may comprise executing firmware instructions on the laser's processor (e.g., micro-controller) and/or loading firmware instructions into volatile memory. In some instances, the firmware instructions remain stored in the firmware store until executed, thus bypassing the load into volatile memory. In general, the firmware store may comprise some type of non-volatile memory store, such as, but not limited to Flash memory, read-only memory (ROM), electronically-erasable programmable read only memory (EEPROM), etc.

In conjunction with the firmware load, the calibration parameters derived above are loaded into firmware functions that comprise runtime functions corresponding to the foregoing calibration equations described above. In other words, the firmware functions used during ongoing laser operations may employ the same or different equations than those used to derive corresponding calibration parameters, examples of which are presented below.

After the laser is initialized, it is ready for ongoing use. During this phase of operations, the laser will typically be tuned to one or more communication channels (i.e., predetermined frequency/wavelength based on a standard communication grid, such as ITU). As depicted by start and end loop blocks 1502 and 1512, the operations of blocks 1504, 1506, 1508 and 1510 are performed in response to each channel change (e.g., input channel command 544), including tuning to a first channel.

In response to a tuning command, an estimated gain medium start current I_{START} is calculated in a block 1504 using the PI curve calibration parameters derived above and a corresponding PI curve function implementing such parameters via execution of firmware instructions. The input values for the function include a target photodiode current PD_{TARGET} and the tuning frequency v.

In a block 1506, the wavelength calibration parameters derived above are used to calculate the filter temperatures T_{1 and T}₂ corresponding to the requested tuning frequency v (or wavelength λ). As discussed above, in the operations of block 814, the laser tuning equation,
T=T(v, dq; A, B, L, q₀) (6)
is solved for T and is programmed into the system's firmware, while the calibration parameters (A, B, q₀ and L) are stored in a non-volatile store. Accordingly, the first operation for wavelength (frequency) tuning is to select which peak, parameterized by dq in the equation 5, should be used to thermally tune to the target wavelength. This is selected by treating the mode number, q₀, as a variable in the equation,

$$\frac{{q}_{0} + dq}{2} = \frac{v}{c} * n ( λ , T ) * L * ( 1 + A * T + B * {T}^{2} ) \qquad ( 5 a )$$

and putting a nominal target tuning temperature for T (for each of T₁ and T₂) and the target frequency for v. This will lead to a fractional value being returned for dq—the nearest peak is selected by rounding this fractional value to an integer. This integer peak, dq, is then inserted back into equation 6 and solved for T.

Once the laser has been initially tuned to a channel, wavelength locking and power control operations are performed on an ongoing basis to keep the channel wavelength (and frequency) locked, while maintaining the laser output at a desired level. In one embodiment, as depicted by the operations of block 1508, a wavelength-locking loop employs a phase dither to induce a modulation in the output of the laser. This will produce a change in transmission characteristics, which can be detected using a feedback signal comprising the photodiode current PD or a change in the gain medium voltage junction V_{J}. Meanwhile, a power control loop is employed in block 1510 to maintain the laser's power output at a desired level. This power control loop employs a servo error derived from the difference between the photodiode current measurement PD and the target photodiode current PD_{TARGET} (as determined from the power calibration function using the desired output power P as frequency v as inputs).

In general, firmware discussed herein will be embodied as machine-executable instructions that are executed by some form of processing core, such as a processor, micro-controller, etc. Thus, embodiments of this invention may be used as or to support a software program executed upon some form of processing core or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The calibration techniques described herein provide several advantages over the conventional schemes that employ lookup tables. There are no specialized test points, such as ITU frequencies, which need to be reached during the calibration processes. During operations, all frequencies can be tuned to with the same performance as the ITU frequencies, increasing flexibility. Additionally, a lookup table can “freeze” in the noise at a given look up point. To test the performance of the lookup table (looking for tuning errors), every point must be investigated. With fewer degrees of freedom, an equation-based calibration can be verified by testing fewer points.

The calibration techniques also employ fewer free parameters. Thus, less data is required to determine those parameters, reducing calibration time. Furthermore, less data is required to verify laser performance, thus reducing test time. Since the free parameters are determined using least square fit schemes, excellent noise cancellation is obtained (square root of N reduction, where N is the number of data points). This reduces the need to average data for accurate calibration, also reducing calibration time. As an illustration of the techniques effectiveness and accuracy, FIG. 16 shows wavelength error data obtained during testing of an actual laser device following the calibration techniques described above over the 84 channels in the C-band communication spectrum.

Furthermore, in the foregoing description of the embodiments, values for PD, I, R, and T are measured in terms of physical units by scaling corresponding A/D measurements. This is not meant to be limiting, but merely one scheme for implementing calibration of the corresponding equations. In general, the techniques disclosed herein may also be employed without requiring measurements to be scaled into units. For example, abstract values derived directly from the A/D measurements may be employed.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
calibrating an operational characteristic of a laser by,
modeling a behavior of the operational characteristic over an operating range for the laser with a corresponding modeling equation;
performing a calibration process on the laser to derive parameters for the modeling equation; and
employing a function based on the modeling equation that employs the parameters derived from the calibration testing to tune the operational characteristic during laser operations.

2. The method of claim 1, wherein the operational characteristic comprises the wavelength of an output generated by the laser, the method further comprising:
defining a wavelength modeling equation to model the wavelength behavior of the laser;
performing a wavelength calibration process to derive parameters corresponding to the wavelength modeling equation; and
employing a wavelength tuning function that employs parameters derived from the wavelength calibration process to tune the wavelength of the laser's output.

3. The method of claim 2, wherein the wavelength of the laser is tuned using first and second thermally-tunable etalons, the method further comprising:
storing parameters derived from the wavelength calibration process in one of memory or a computer accessible to the laser; and in response to a tuning command,
retrieving the parameters;
generating initial temperature settings for the first and second thermally-tunable etalons using a function that employs the parameters, and
adjusting temperatures for the first and second thermally-tunable etalons based on the respective initial temperature settings that are generated.

4. The method of claim 2, wherein the wavelength calibration process includes varying input variables including optical frequency, the temperature of at least one etalon filter, and a relative peak integer used to identify a transmission peak of said at least one etalon filter.

5. The method of claim 4, wherein the wavelength modeling equation comprises:
$${q}_{0} + dq = \frac{v}{c} * 2 * n ( λ , T ) * L * ( 1 + A * T + B * {T}^{2} )$$
wherein q₀ is the absolute mode number of the relative mode 0, dq is the relative peak integer, v is the optical frequency, c is the speed of light, T is the filter temperature, n(λ, T) is the index of refraction for said at least one etalon material at a corresponding wavelength and temperature, L is the thickness of said at least one etalon, and parameters A and B correspond to corrections to the slope (A) and curvature (B) of a temperature scale.

6. The method of claim 1, wherein the operational characteristic comprises the laser's output power, the method further comprising:
defining a modeling equation to model a relationship between the laser's output power P and gain medium input current I, the modeling equation defining a PI curve for the laser; and
performing a PI curve calibration process to derive parameters for the PI curve.

7. The method of claim 6, further comprising:
employing an internal power measurement made by a component in the laser to calibrate the PI curve; and
storing parameters derived from the PI curve calibration on-board the laser.

8. The method of claim 6, further comprising:
calculating an estimated gain medium start current based on parameters derived from performing the PI curve calibration process and the modeling equation; and
supplying a gain medium for the laser with the gain medium start current in response to a command to tune the laser.

9. The method of claim 6, wherein the modeling equation for the PI curve comprises:
$$\begin{matrix}PD = η * ( I - {I}_{th} ) * \frac{( 1 - 0.5 * ( I - {I}_{th} )}{( {I}_{r} - {I}_{th} )} \\ wherein , \\ {I}_{th} = {a}_{0} + {a}_{1} * v + {a}_{2} * {v}^{2} + {a}_{3} * {v}^{3} \\ and , \\ η = {b}_{0} + {b}_{1} * v + {b}_{2} * {v}^{2} + {b}_{3} * {v}^{3}\end{matrix}$$
wherein Ir is a quadratic parameter describing a thermal rollover of the PI curve, a₀, a₁, a₂, a₃, b₀, b₁, b₂, and b₃ are quadratic parameters for the PI curve, v is the optical frequency, I is the gain medium current, Iₜₕ is the threshold current for the gain medium current, and PD is a power measurement measured internally by the laser.

10. The method of claim 1, wherein the operational characteristic relates to the laser's output power, the method further comprising:
defining a modeling equation that relates the output power measured by an external power measurement device to a corresponding internal power measurement made by the laser itself;
performing a power calibration process to derive parameters corresponding to the modeling equation; and
employing the parameters that are derived in a function based on the modeling equation to control the output power of the laser.

11. The method of claim 10, further comprising:
splitting off a portion of the optical output of the laser; and
performing the internal power measurement by measuring the portion of the optical output of the laser that is split off with a photodiode.

12. The method of claim 10, wherein the modeling equation comprises:
PD=P*d₀*(1+d₁*v+d₂*v²+d₃*v³)
wherein the parameters include d₀, d₁, d₂, and d₃ are quadratic parameters, v is the optical frequency, P is the laser's output power measured externally, and PD is an internal measurement of the laser's output power.

13. The method of claim 1, further comprising:
employing first and second thermally-tunable etalons as filters for the laser;
performing calibration of first and second temperature sensors respectively coupled to the first and second thermally-tunable etalons; and
storing calibration data for each of the first and second temperature sensors in one of memory on-board the laser, external memory accessible to the laser, or on a computer accessible to the laser.

14. The method of claim 1, further comprising:
storing data corresponding to the parameters that are derived in a non-volatile memory store on-board the laser or accessible to the laser; and
executing firmware either stored on-board the laser or in an external memory accessible to the laser to tune the operational characteristic of the laser, wherein execution of the firmware generates tuning data using functions that employ the parameters that are stored.

15. The method of claim 1, wherein the laser comprises an external cavity diode laser.

16. A method comprising:
modeling a wavelength behavior of a laser using a wavelength modeling equation, the laser comprising a tunable external cavity diode laser employing first and second thermally-tunable etalons;
performing a wavelength calibration for the external cavity diode laser to derive parameters corresponding to the wavelength modeling equation;
storing the parameters in one of memory on-board the external cavity diode laser, in external memory accessible to the external cavity diode laser, or on a computer linked in communication with the external cavity diode laser; and
employing the parameters in a wavelength tuning function during ongoing external cavity diode laser operation to tune the wavelength of the external cavity diode laser.

17. The method of claim 16, further comprising:
modeling a power (P) versus gain medium current (I) characteristic of the external cavity diode laser using a corresponding PI curve modeling equation;
deriving parameters corresponding to the PI curve modeling equation during a calibration process to obtain a PI curve for the external cavity diode laser; and
employing the parameters in a function corresponding to the modeling equation to tune the output power of the external cavity diode laser.

18. The method of claim 17, further comprising:
modeling an output power vs. internal power measurement of the external cavity diode laser using a corresponding modeling equation;
performing a power calibration process to derive parameters corresponding to the modeling equation; and
employing the parameters that are derived in a power function to tune the output power of the external cavity diode laser.

19. The method of claim 16, further comprising:
performing calibration of first and second temperature sensors respectively coupled to the first and second thermally-tunable etalons;
storing calibration data for each of the first and second temperature sensors in one of memory on-board the laser, in external memory accessible to the laser, or on a computer linked in communication with the laser; and
employing the temperature sensor calibration data to control the temperature of the first and second thermally-tunable etalons.

20. A machine-readable medium, having instructions stored thereon, which if executed perform operations comprising:
retrieving parameters from a storage device on-board a laser on which the instructions are executed, the parameters corresponding to parameters defined by a modeling equation used to model a behavior of an operational characteristic of the laser and comprising values derived during calibration of the operational characteristic of a laser; and
employing the parameters in a function related to the modeling equation to tune the operational characteristic of the laser,
wherein a portion of the instructions comprise the function.

21. The machine-readable medium of claim 20, wherein the operational characteristic that is tuned is the wavelength of an output generated by the laser, and the function comprises a wavelength-tuning function employing parameters derived from a wavelength calibration process.

22. The machine-readable medium of claim 21, wherein the laser includes first and second thermally-tunable etalons that are used to tune the wavelength of the laser's output, and execution of the instructions performs further operations including:
in response to a tuning command specifying one of a tuning frequency or wavelength,
employing a wavelength-tuning function to generate temperature values for each of the first and second thermally-tunable etalons; and
sending out control signals to temperature control elements for the first and second thermally-tunable etalons, the control signals corresponding to the temperature values that are generated.

23. The machine-readable medium of claim 20, wherein the operational characteristic that is tuned is the output power of the laser, and the function comprises an output power function employing parameters derived from at least one power calibration process.

24. The machine-readable medium of claim 23, wherein the parameters included parameters derived from calibration of a power vs. gain medium current curve for the laser, and wherein execution of the instructions performs further operation including:
receiving a tuning command specifying a new tuning frequency and output power level; and
calculating a gain medium start current using the new tuning frequency and output power levels as inputs into the output power function.

25. The machine-readable medium of claim 24, wherein execution of the instructions performs further operations including:
determining a target power value to be measured by an on-board power measurement device that corresponds to the output power level; and
employing the target power value and current power values measured by the on-board power measurement device in a power control loop to control the output power of the laser.

26. A tunable laser, comprising:
a gain medium, to produce an optical emission in response to an input current;
first and second thermally-tunable etalons, optically coupled to provide a tunable feedback to the gain medium, the first and second thermally-tunable etalons employed to tune the wavelength of an output emitted from the laser;
a processing element; and
a non-volatile store, comprising either an on-board memory or an external memory linked in communication with the tunable laser, in which firmware instructions and model parameters are stored, the parameters corresponding to parameters defined by modeling equations used to model the behavior of corresponding operational characteristics of the laser and comprising values derived during calibration of those operational characteristics, wherein execution of the firmware instructions performs operations including:
retrieving wavelength tuning parameters in response to a tuning command requesting to tune the tunable laser to a new channel; and
employing the wavelength tuning parameters in a wavelength tuning function to tune the wavelength of an optical output generated by the laser,
wherein a portion of the instructions comprise the wavelength tuning function.

27. The tunable laser of claim 26, wherein the tunable laser comprises an external cavity diode laser comprising:
a gain medium having a front facet and rear facet;
an external cavity, optically coupled to the front facet of the gain medium; and
first and second thermally-tunable etalons disposed in the external cavity.

28. The tunable laser of claim 26, further comprising:
first and second temperature sensors, respectively coupled to the first and second thermally-tunable etalons;
thermal calibration parameters derived from thermal calibration of the first and second temperature sensors, stored in the non-volatile storage;
and wherein execution of the firmware instructions performs further operations including:
employing the thermal calibration parameters to control the temperature of the first and second thermally-tunable etalons.

29. The tunable laser of claim 26, further comprising:
a beam splitter, optically coupled to an output of the tunable laser to split off a portion of the output;
a photodiode, optically coupled to receive the split off portion of the tunable laser output; and
output power calibration parameters, stored in the non-volatile store, employed by an output power function comprising a portion of the firmware that relates an internal power measurement made by the photodiode with an output power of the tunable laser,
and wherein execution of the firmware instructions performs further operations including,
determining a target power value to be measured by the photodiode corresponding to a target output power level; and
employing the target power value and a current power value measured by the photodiode in a power control loop to control the output power of the tunable laser.

30. The tunable laser of claim 29, further comprising:
parameters derived from calibration of a power vs. gain medium current (PI) curve for the tunable laser, stored in the non-volatile store; and
an output power function that employs the parameters derived from the PI curve calibration, comprising a portion of the firmware instructions;
and wherein execution of the instructions performs further operation including,
receiving a tuning command specifying a new tuning frequency and output power level; and
calculating a starting gain medium current using a tuning frequency and output power level specified by a tuning command as inputs into the output power function.
